(19) United States
(12) Patent Application Publication
(10) Pub. No.: US 2021/0135320 A1
(43) Pub. Date: May 6, 2021

(54) BATTERY AND BATTERY PACK

(71) Applicant: KABUSHIKI KAISHA TOSHIBA, Tokyo (JP)

(72) Inventors: Masahiro MURATA, Yokohama (JP); Yasuaki MURASHI, Yokohama (JP); Tatsuya SHINODA, Yokohama (JP)

(73) Assignee: KABUSHIKI KAISHA TOSHIBA, Tokyo (JP)

(21) Appl. No.: 17/141,342

(22) Filed: Jan. 5, 2021

Related U.S. Application Data
(63) Continuation of application No. PCT/JP2018/039493, filed on Oct. 24, 2018.

(51) Int. Cl. H01M 50/533; H01M 10/0587; H01M 50/159; H01M 50/538; H01M 50/528

(52) U.S. Cl. CPC H01M 50/533; H01M 10/0587; H01M 50/528; H01M 50/538; H01M 50/159

(57) ABSTRACT

According to an embodiment, a battery is provided. The battery includes a first lead clamping a current-collecting tab wound into multiple layers. The first lead includes: a joint plate portion electrically connected to the second lead; and a cover plate portion opposing the joint plate portion with the current-collecting tab wound into multiple layers interposed therebetween. The cover plate portion includes a first plate portion and a second plate portion extending continuously from the first plate portion. The second plate portion includes a protrusion protruding relative to the first plate portion along a direction in which the second lead extends. The protrusion is curved toward at least one end of the wound electrode group.

### CROSS-REFERENCE TO RELATED APPLICATIONS

This application is a Continuation Application of PCT Application No. PCT/JP2018/039493, filed Oct. 24, 2018, the entire contents of which are incorporated herein by reference.

### FIELD

Embodiments described herein relate generally to a battery and a battery pack.

### BACKGROUND

Since lithium ion batteries have high energy densities, they are expected to be used as power sources for electric vehicles (EV), hybrid vehicles (HEV), electric motorcycles, forklifts, and the like. In order to obtain an electric power source having a larger capacity, a battery module formed by electrically connecting a plurality of batteries has been developed.

A battery includes, for example, a metallic outer can, a wound electrode group housed in the outer can, leads, and a metallic lid attached to an opening of the outer can. For example, the lid is welded to the opening of the outer can. The wound electrode group includes a positive electrode current-collecting tab at one end in the winding axis direction, and a negative electrode current-collecting tab at the other end in the winding axis direction. The positive electrode current-collecting tab is connected with a positive electrode lead, and the negative electrode current-collecting tab is connected with a negative electrode lead. The lid is provided with a positive electrode terminal and a negative electrode terminal. These terminals are fixed to the lid by swaging, for example, with a gasket interposed therebetween, so that the terminals are insulated from the lid and the outer can. The positive and negative electrode leads connected to the current-collecting tabs are electrically connected to the terminals of the positive electrode and the negative electrode, respectively.

In a structure where a tab assembly wound into multiple layers is connected to a lead member by ultrasonic waves or the like to extract a current to the outside, a backup lead is used to bundle the tab assembly. In the portion where the tab wound into multiple layers is bundled by the backup lead and subjected to ultrasonic joining, the layers of the tab are in close contact with each other. Thus, the impregnating of an electrolytic solution decreases. That is, in the portion where the tab wound into multiple layers is bundled by the backup lead, an electrolytic solution may be less likely to permeate in a direction parallel to the winding axis direction.

### BRIEF DESCRIPTION OF THE DRAWINGS

FIG. 1 is a perspective view of an external of a battery according to an embodiment.

FIG. 2 is an unfolded perspective view of the battery shown in FIG. 1.

FIG. 3 is an unfolded perspective view of a cap body included in the battery shown in FIG. 1.

FIG. 4 is an unfolded view of a wound electrode group included in the battery shown in FIG. 1.

FIG. 5 is a front view of the battery shown in FIG. 1.

FIG. 6 is an enlarged view of the front and the side of a periphery of a negative electrode backup lead of an example of the battery according to the embodiment.

FIG. 7 is a perspective view showing an example of the negative electrode backup lead according to the embodiment.

FIG. 8 is a front view of the negative electrode backup lead shown in FIG. 7, as viewed from the side.

FIG. 9 is a top view of the negative electrode backup lead shown in FIG. 7, as viewed from the upper side.

FIG. 10 is a front view of the negative electrode backup lead shown FIG. 7 in an unfolded state.

FIG. 11 is a diagram schematically showing an example of a flow of an electrolytic solution in the battery shown in FIG. 6.

FIG. 12 is a diagram schematically showing an example of a flow of an electrolytic solution in a battery according to a reference example.

FIG. 13 is an enlarged view of the front and the side of a periphery of a negative electrode backup lead of another example of the battery according to the embodiment.

FIG. 14 is a perspective view showing another example of the negative electrode backup lead according to the embodiment.

FIG. 15 is a front view of the negative electrode backup lead shown in FIG. 14, as viewed from the side.

FIG. 16 is a front view of the negative electrode backup lead shown in FIG. 14 in an unfolded state.

FIG. 17 is a perspective view showing still another example of the negative electrode backup lead according to the embodiment.

FIG. 18 is a front view of the negative electrode backup lead shown in FIG. 17, as viewed from the side.

FIG. 19 is a perspective view showing still another example of the negative electrode backup lead according to the embodiment.

FIG. 20 is a front view of the negative electrode backup lead shown in FIG. 19, as viewed from the side.

FIG. 21 is an exploded perspective view showing an example of a battery pack according to an embodiment.

FIG. 22 is a block diagram showing an example of an electric circuit of the battery pack shown in FIG. 21.

### DETAILED DESCRIPTION

According to an embodiment, a battery is provided. The battery includes: an outer can including a side wall and a bottom wall and including an opening on an opposite side of the bottom wall; an electrolytic solution; a wound electrode group housed in the outer can so that a winding axis direction of the wound electrode group intersects with the side wall, and including a current-collecting tab wound into multiple layers arranged at at least one end of the wound electrode group; a first lead clamping the current-collecting tab wound into multiple layers; a second lead electrically connected to the first lead; and a metallic lid attached to the opening of the outer can and including a terminal. The first lead includes: a joint plate portion electrically connected to the second lead; a cover plate portion opposing the joint plate portion with the current-collecting tab wound into multiple layers interposed therebetween; and a connection plate portion connecting the joint plate portion and the cover plate portion and facing at least one end of the wound electrode group. The second lead includes a substrate electrically connected to the terminal, and a leg portion extending in a direction perpendicular to the winding axis direction of the wound electrode group, wherein the leg portion is electrically connected to the joint plate portion. The cover plate portion includes: a first plate portion adjacent to the connection plate portion and forming a part of the cover plate portion; and a second plate portion extending continuously from the first plate portion and forming another part of the cover plate portion. The second plate portion includes: a connected side connected to the first plate portion; an unconnected side extending along a direction in which the connected side extends and not connected to the first plate portion; and a counter side positioned on an opposite side of the connected side and the unconnected side. The second plate portion includes a protrusion protruding relative to the first plate portion along a direction in which the leg portion extends. The unconnected side and a part of the counter side at the protrusion is curved toward at least one end of the wound electrode group.

According to another embodiment, a battery pack is provided. The battery pack includes the nonaqueous electrolyte battery according to the embodiment.

### First Embodiment

According to a first embodiment, a battery is provided. The battery includes: an outer can including a side wall and a bottom wall and including an opening on an opposite side of the bottom wall; an electrolytic solution; a wound electrode group housed in the outer can so that a winding axis direction of the wound electrode group intersects with the side wall, and including a current-collecting tab wound into multiple layers arranged at at least one end of the wound electrode group; a first lead clamping the current-collecting tab wound into multiple layers; a second lead electrically connected to the first lead; and a metallic lid attached to the opening of the outer can and including a terminal. The first lead includes: a joint plate portion electrically connected to the second lead; a cover plate portion opposing the joint plate portion with the current-collecting tab wound into multiple layers interposed therebetween; and a connection plate portion connecting the joint plate portion and the cover plate portion and facing at least one end of the wound electrode group. The second lead includes a substrate electrically connected to the terminal, and a leg portion extending in a direction perpendicular to the winding axis direction of the wound electrode group, wherein the leg portion is electrically connected to the joint plate portion. The cover plate portion includes: a first plate portion adjacent to the connection plate portion and forming a part of the cover plate portion; and a second plate portion extending continuously from the first plate portion and forming another part of the cover plate portion. The second plate portion includes: a connected side connected to the first plate portion; an unconnected side extending along a direction in which the connected side extends and not connected to the first plate portion; and a counter side positioned on an opposite side of the connected side and the unconnected side. The second plate portion includes a protrusion protruding relative to the first plate portion along a direction in which the leg portion extends. The unconnected side and a part of the counter side at the protrusion is curved toward at least one end of the wound electrode group.

Hereinafter, embodiments will be described with reference to the drawings.

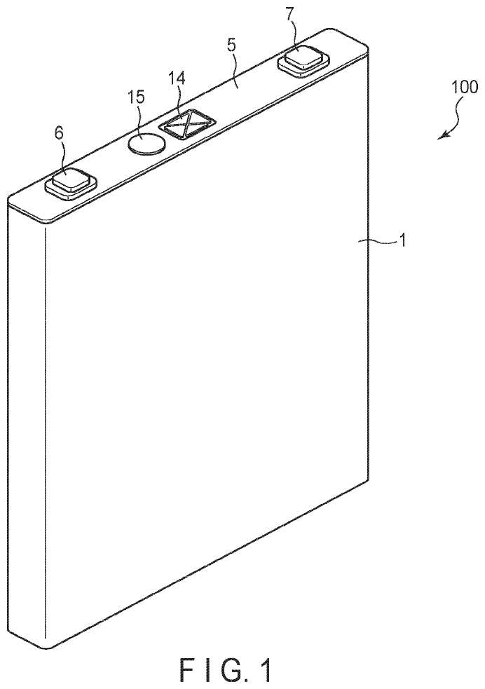

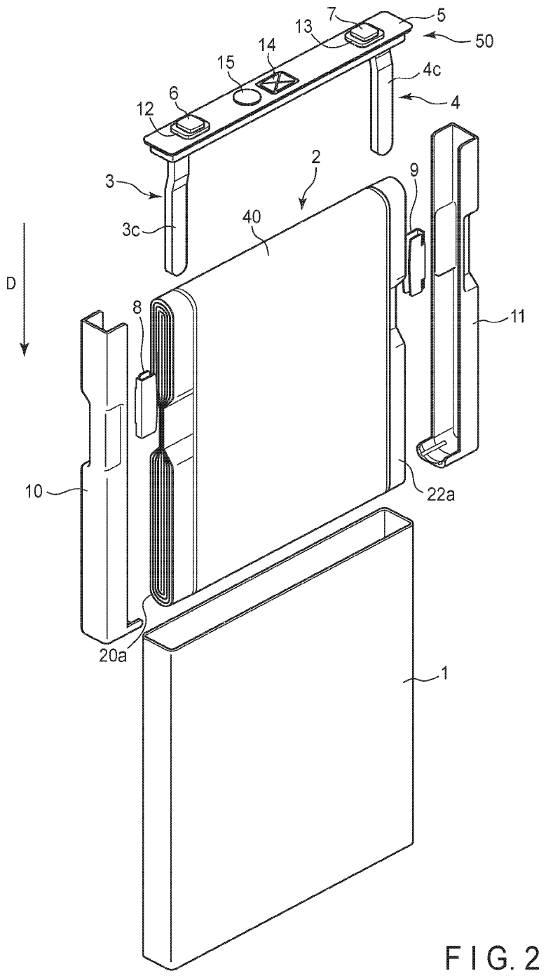

As an example of a battery, FIG. 1 shows an external of a nonaqueous electrolyte battery 100, and FIG. 2 shows an unfolded perspective view of the nonaqueous electrolyte battery. The battery 100 includes an outer can 1, a flat wound electrode group 2, a positive electrode lead 3 (second positive electrode lead), a negative electrode lead (second negative electrode lead), a lid 5, a positive electrode terminal 6, a negative electrode terminal 7, a positive electrode backup lead 8 (first positive electrode lead), a negative electrode backup lead 9 (first negative electrode lead), a positive electrode insulating cover 10, a negative electrode insulating cover 11, a positive electrode gasket 12, a negative electrode gasket 13, a safety valve 14, a lid 15 for an electrolyte injection port, and an electrolytic solution (not shown). It is preferable that the electrolytic solution be present in the outer can 1 and fill the outer can 1.

The outer can 1 has a bottomed rectangular tube shape. The outer can 1 includes a side wall and a bottom wall, and includes an opening on an opposite side of the bottom wall; The outer can 1 is made of a metal such as aluminum, an aluminum alloy, iron, or stainless steel. The wound electrode group 2 is housed so that a winding axis direction of the wound electrode group 2 intersects with the side wall of the outer can 1.

The wound electrode group 2 includes: a positive electrode current-collecting tab 20a wound into multiple layers, which is arranged at one end in the winding axis direction; and a negative electrode current-collecting tab 22a wound into multiple layers, which is arranged at the other end in the winding axis direction. FIG. 4 shows an unfolded view of the wound electrode group 2. A positive electrode 20 includes a strip-shaped positive electrode current collector 20c made of, for example, a metal foil, and a positive electrode active material-containing layer 20b formed on either one or both surfaces of the positive electrode current collector 20c. The positive electrode active material-containing layer 20b is formed on the strip-shaped positive electrode current collector 20c such that a region (non-coated portion) having a certain width remains on one end side along a longitudinal direction of the positive electrode current collector 20c. Said non-coated portion is a portion where the positive electrode current collector 20c is exposed, and serves as the positive electrode current-collecting tab 20a. Likewise, a negative electrode 22 includes a strip-shaped negative electrode current collector 22c made of, for example, a metal foil, and a negative electrode active material-containing layer 22b formed on either one or both surfaces of the negative electrode current collector 22c. The negative electrode active material-containing layer 22b is formed on the strip-shaped negative electrode current collector 22c such that a region (non-coated portion) having a certain width remains on the other end side (the side opposite to one end of the positive electrode 20) along a longitudinal direction of the negative electrode current collector 22c. Said non-coated portion is a portion where the negative electrode current collector 22c is exposed, and serves as the negative electrode current-collecting tab 22a.

The positive electrode 20 and the negative electrode 22 are stacked alternately with a strip-shaped separator 21. For example, two separators, a separator 21a and a separator 21b are used for the separator 21. On this occasion, the positive electrode current-collecting tab 20a is arranged on one end side in the winding axis direction, and the negative electrode current-collecting tab 22a is arranged at the other end side in the winding axis direction. The separator 21a stacked below the negative electrode 22 is arranged so that one end of the separator 21a along the longitudinal direction thereof is positioned on an inner side with respect to the end of the negative electrode 22 that is positioned on the side of the negative electrode current-collecting tab. Thus, the negative electrode current-collecting tab 22a protrudes from the positive electrode active material-containing layer 20b the negative electrode active material-containing layer 22b and the separator 21a which constitute the wound electrode group 2. Also, the separator 21a is arranged so that the other end of the separator 21a along the longitudinal direction thereof is positioned on an outer side with respect to the other end of the negative electrode 22. The separator 21b interposed between the positive electrode 20 and the negative electrode 22 is arranged so that one end of the separator 21b along the longitudinal direction thereof is positioned on an inner side with respect to the end of the positive electrode 20 that is positioned on the side of the positive electrode current-collecting tab. Thus, the positive electrode current-collecting tab 20a protrudes from the positive electrode active material-containing layer 20b the negative electrode active material-containing layer 22b and the separator 21b which constitute the wound electrode group 2. Also, the separator 21b is arranged so that the other end of the separator 21b along the longitudinal direction thereof is positioned on an outer side with respect to the other end of the positive electrode 20.

The stacked separator 21a negative electrode 22, separator 21b and positive electrode 20 are wound and then pressed to form the flat wound electrode group 2.

For example, as shown in FIG. 2, the wound electrode group 2 is fixed with an insulating tape 40. The insulating tape 40 covers the outermost periphery of the wound electrode group 2 except for the current-collecting tab, so as to insulate the outermost periphery except for the current-collecting tab. The insulating tape 40 may be wound one or more times.

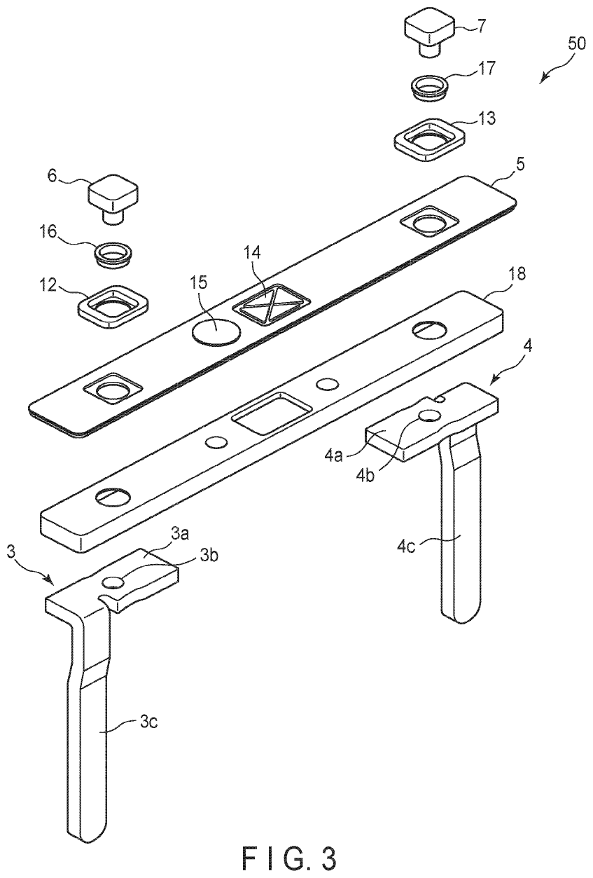

FIG. 3 shows an unfolded perspective view of an example of a cap body 50. The cap body 50 is formed of, for example, a lid 5, an insulator 18, a positive electrode lead 3 (second positive electrode lead), a negative electrode lead 4 (second negative electrode lead), a positive electrode terminal 6, a negative electrode terminal 7, a positive electrode gasket 12 (first positive electrode gasket 12), a second positive electrode gasket 16, a negative electrode gasket 13 (first negative electrode gasket 13), and a second negative electrode gasket 17.

The lid 5 is a molded member made of metal or alloy such as aluminum, an aluminum alloy, iron, or stainless steel.

The positive electrode lead 3 as a second positive electrode lead is a conductive member that electrically connects the positive electrode terminal 6 and the positive electrode backup lead 8 as a first positive electrode lead shown in FIG. 2, etc. The positive electrode lead 3 is a conductive member such as aluminum or an aluminum alloy.

The negative electrode lead 4 as a second negative electrode lead is a conductive member that electrically connects the negative electrode terminal 7 and the negative electrode backup lead 9 as a first negative electrode lead shown in FIG. 2, etc. The negative electrode lead 4 is a conductive member such as aluminum or an aluminum alloy.

The positive electrode terminal 6 is an electrode terminal for the positive electrode of the battery that is provided on the lid 5. The positive electrode terminal 6 is formed of a conductive member such as aluminum or an aluminum alloy. The positive electrode terminal 6 is fixed to the lid 5 with the insulating first positive electrode gasket 12 and the insulating second positive electrode gasket 16 interposed therebetween. The positive electrode terminal 6 is electrically connected to the positive electrode 20 via the positive electrode lead 3 and the positive electrode backup lead 8.

The negative electrode terminal 7 is an electrode terminal for the negative electrode of the battery that is provided on the lid 5. The negative electrode terminal 7 is formed of a conductive member such as aluminum or an aluminum alloy. The negative electrode terminal 7 is fixed to the lid 5 with the insulating first negative electrode gasket 13 and the insulating second negative electrode gasket 17 interposed therebetween. The negative electrode terminal 7 is electrically connected to the negative electrode 22 via the negative electrode lead 4 and the negative electrode backup lead 9.

The positive electrode insulating cover 10 shown in FIG. 2, etc., is an insulating member that covers the positive electrode lead 3 and the positive electrode backup lead 8. The positive electrode insulating cover 10 engages with one end of the wound electrode group 2 including the positive electrode current-collecting tab 20a. The positive electrode insulating cover 10 is preferably an insulating and heat-resistant member. The positive electrode insulating cover 10 is preferably a resin molded body, a molded body made of a material consisting mainly of paper, a member obtained by coating a molded body made of a material consisting mainly of paper with a resin, or the like. A polyethylene resin or a fluororesin is preferably used as the resin. By using the positive electrode insulating cover 10, the positive electrode 20 and the outer can 1 are insulated from each other, and the current-collecting tab region (current-collecting tab, lead, backup lead) can be protected from external impact.

The negative electrode insulating cover 11 shown in FIG. 2, etc., is an insulating member that covers the negative electrode lead 4 and the negative electrode backup lead 9. The negative electrode insulating cover 11 engages with one end of the wound electrode group 2 including the negative electrode current-collecting tab 22a. The material, shape, and the like of the negative electrode insulating cover 11 are the same as those of the positive electrode insulating cover 10. Descriptions common to the positive electrode insulating cover 10 and the negative electrode insulating cover 11 are omitted.

The first positive electrode gasket 12 and the second positive electrode gasket 16 are members that insulate the positive electrode terminal 6 from the outer can 1. The positive electrode gasket is preferably a resin molded body having solvent resistance and flame retardancy. For example, a polyethylene resin, a fluororesin, or the like is used for the positive electrode gasket.

The first negative electrode gasket 13 and the second negative electrode gasket 17 are members that insulate the negative electrode terminal 7 from the outer can 1. The negative electrode gasket is preferably a resin molded body having solvent resistance and flame retardancy. For example, a polyethylene resin, a fluororesin, or the like is used for the negative electrode gasket.

The safety valve 14 is a member provided to the lid 5 and functioning as a pressure reducing valve that reduces the internal pressure of the outer can 1 when the internal pressure of the outer can 1 increases. The safety valve 14 is preferably provided, but may be omitted in consideration of the conditions of the protection mechanism of the battery, the electrode material, and the like.

The lid 15 for an electrolyte injection port seals a hole for injecting an electrolytic solution. The lid 15 for an electrolyte injection port is made of metal such as aluminum, an aluminum alloy, iron, or stainless steel.

The metallic lid 5 is fixed, in an air tight manner, to the opening of the outer can 1 shown in FIG. 1 by, for example, a welding process. The positive electrode terminal 6 is fixed to the lid 5 by swaging with the first positive electrode gasket 12 and the second positive electrode gasket 16 interposed therebetween. The negative electrode terminal 7 is fixed to the lid 5 by swaging with the first negative electrode gasket 13 and the second negative electrode gasket 17 interposed therebetween. The positive electrode terminal 6 and the negative electrode terminal 7 protrude from the back surface of the lid 5 to the inside of the outer can 1.

As shown in FIG. 3, the positive electrode lead 3 includes a substrate 3a electrically connected to the positive electrode terminal 6, a through hole 3b opened in the substrate 3a and a leg portion 3c extending from the substrate 3a in a direction perpendicular to the direction in which the substrate 3a extends. The substrate 3a is in contact with the back surface of the lid 5 with the insulator 18 interposed therebetween. The positive electrode terminal 6 protruding from the back surface of the lid 5 is fixed to the through hole 3b by swaging.

As shown in FIG. 2, the leg portion 3c of the positive electrode lead 3 is electrically connected to at least the positive electrode backup lead 8. The leg portion 3c of the positive electrode lead 3 may include a portion in direct contact with the positive electrode current-collecting tab 20a. The positive electrode backup lead 8 and the leg portion 3c of the positive electrode lead are joined by, for example, ultrasonic joining. A more specific joining method will be described later.

In a manner similar to the positive electrode lead 3, the negative electrode lead 4 includes a substrate 4a electrically connected to the negative electrode terminal 7, a through hole 4b opened in the substrate 4a and a leg portion 4c extending from the substrate 4a in a direction perpendicular to the direction in which the substrate 4a extends. The substrate 4a is in contact with the back surface of the lid 5 with the insulator 18 interposed therebetween. The negative electrode terminal 7 protruding from the back surface of the lid 5 is fixed to the through hole 4b by swaging.

As shown in FIG. 2, the leg portion 4c of the negative electrode lead 4 is electrically connected to at least the negative electrode backup lead 9. The leg portion 4c of the negative electrode lead 4 may include a portion in direct contact with the negative electrode current-collecting tab 22a. The negative electrode backup lead 9 and the leg portion 4c of the negative electrode lead 4 are joined by, for example, ultrasonic joining. A more specific joining method will be described later.

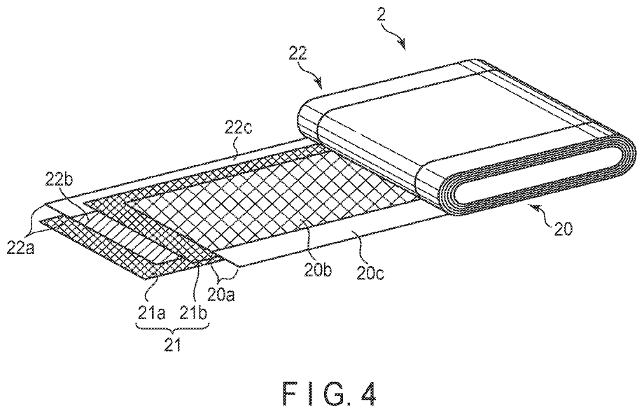

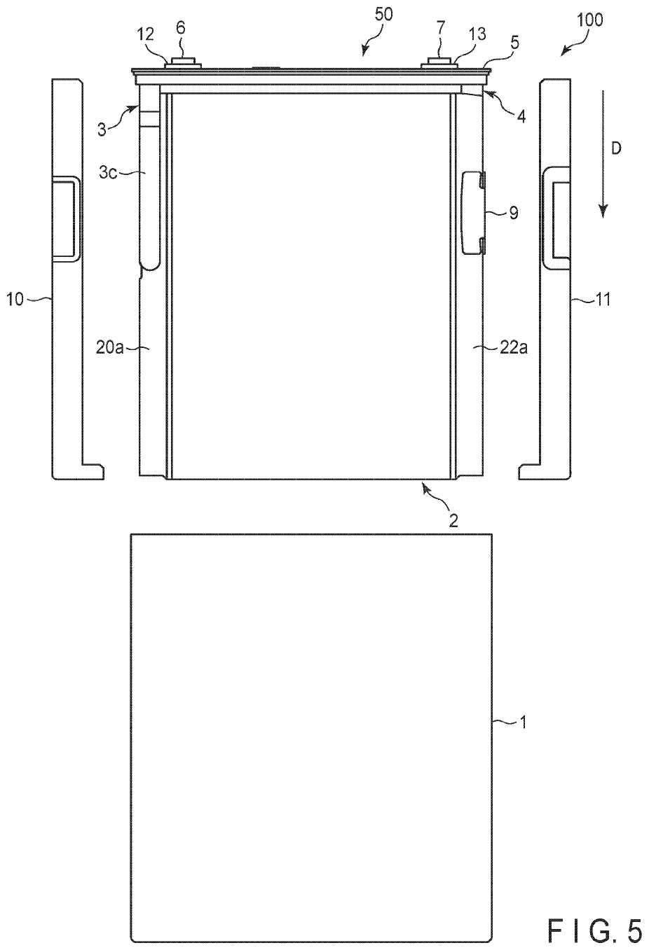

FIG. 5 is a front view of a state in which the wound electrode group 2, the cap body 50, the positive electrode insulating cover 10, and the negative electrode insulating cover 11 are taken out from the battery 100. The negative electrode current-collecting tab 22a wound into multiple layers is clamped and bundled by the negative electrode backup lead 9. The negative electrode current-collecting tab 22a is clamped by the negative electrode backup lead 9, for example, in a direction parallel to the winding axis direction of the wound electrode group 2. Although not shown in the figure, the positive electrode current-collecting tab 20a wound into multiple layers is clamped and bundled by the positive electrode backup lead 8. The positive electrode current-collecting tab 20a is clamped by the positive electrode backup lead 8, for example, in a direction parallel to the winding axis direction of the wound electrode group 2.

As shown in FIG. 5, the leg portion 3c of the positive electrode lead 3 extends in a direction perpendicular to the winding axis direction of the wound electrode group 2. Although not shown in FIG. 5, the leg portion 3c is electrically connected to the positive electrode backup lead 8. The leg portion 4c of the negative electrode lead 4 extends in a direction perpendicular to the winding axis direction of the wound electrode group 2. The direction D in which the leg portion 4c extends is shown in FIG. 5. The direction D in which the leg portion 4c extends is, for example, a direction perpendicular to the winding axis direction of the wound electrode group 2. The direction D in which the leg portion 4c extends is also shown in FIG. 2. Although not shown in FIG. 5, the leg portion 4c is electrically connected to the negative electrode backup lead 9. Thus, the wound electrode group 2 and the cap body 50 are electrically connected to each other.

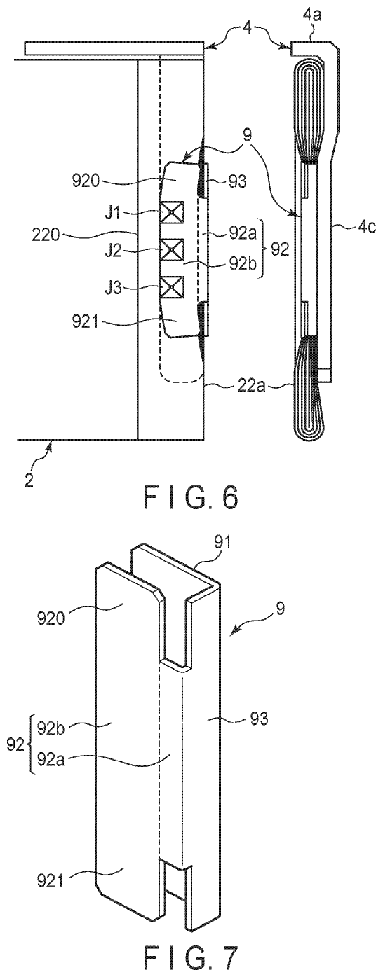

Next, the positive electrode backup lead 8 and the negative electrode backup lead 9 will be described in detail with reference to FIGS. 6 to 20. Since the positive electrode backup lead 8 has the same shape as that of the negative electrode backup lead 9, the illustration of the positive electrode backup lead 8 is omitted in FIGS. 6 to 20.

In the battery according to the embodiment, the positive electrode backup lead 8 and the negative electrode backup lead 9 may not have the same shape. However, at least one of the positive electrode backup lead 8 or the negative electrode backup lead 9 has a shape described below.

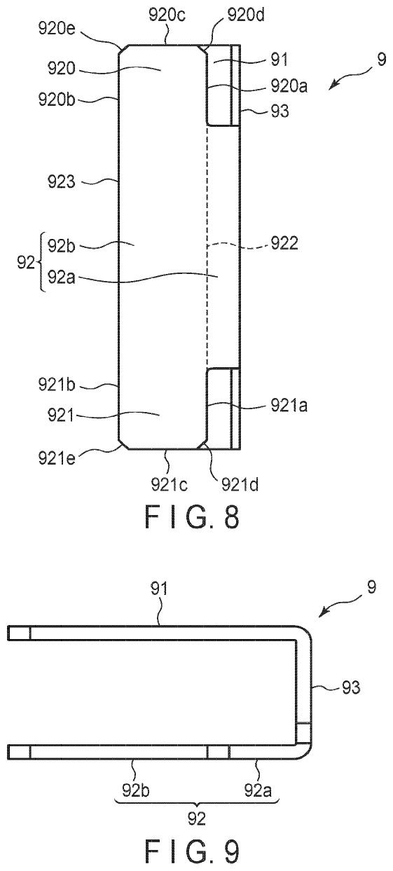

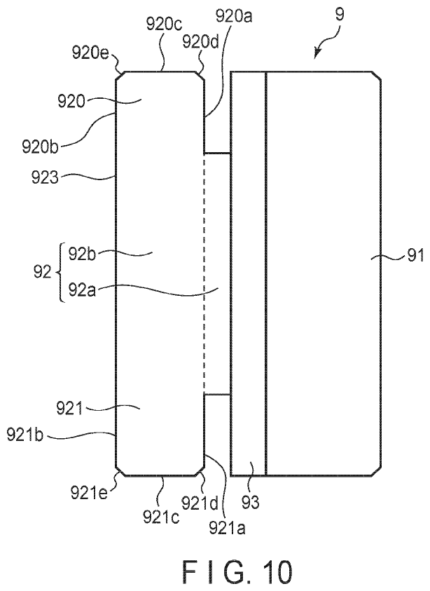

FIG. 6 is an enlarged view of the front and the side of a periphery of a negative electrode backup lead of an example of the battery according to the embodiment. FIG. 7 is a perspective view showing an example of the negative electrode backup lead 9 according to the embodiment. FIG. 8 is a front view of the negative electrode backup lead 9 shown in FIG. 7, as viewed from the side. FIG. 9 is a top view of the negative electrode backup lead 9 shown in FIG. 7, as viewed from the upper side. FIG. 10 is a front view of the negative electrode backup lead 9 shown FIG. 7 in an unfolded state.

The negative electrode backup lead 9 (first negative electrode lead) includes a joint plate portion 91, a cover plate portion 92, and a connection plate portion 93. The joint plate portion 91 is electrically connected to the negative electrode lead 4 (second negative electrode lead). The cover plate portion 92 opposes the joint plate portion 91 with the negative electrode current-collecting tab 22a wound into multiple layers interposed therebetween. The connection plate portion 93 connects the joint plate portion 91 and the cover plate portion 92, and faces one end of the wound electrode group 2.

The cover plate portion 92 is adjacent to the connection plate portion 93. The cover plate portion 92 includes: a first plate portion 92a forming a part of the cover plate portion 92; and a second plate portion 92b extending continuously from the first plate portion 92a and forming another part of the cover plate portion 92. Each of the joint plate portion 91, the first plate portion 92a the second plate portion 92b and the connection plate portion 93 has, for example, a rectangular plate shape. With each of the joint plate portion 91, the first plate portion 92a the second plate portion 92b and the connection plate portion 93 having a rectangular shape, when the negative electrode current-collecting tab 22a wound into multiple layers is to be bundled, the negative electrode current-collecting tab 22a can be clamped by the negative electrode backup lead 9 with high joining strength even when the width of the negative electrode current-collecting tab 22a in the winding axis direction of the wound electrode group 2 is small. In other words, since the width of the negative electrode current-collecting tab 22a in the winding axis direction of the wound electrode group 2 can be reduced, the width of the negative electrode active material-containing layer (coated portion) in the winding axis direction of the wound electrode group 2 can be increased. As a result, the capacity of the battery can be increased.

As shown in FIGS. 6 to 10, etc., the second plate portion 92b includes an upper protrusion 920 and a lower protrusion 921 protruding relative to the first plate portion 92a along a direction in which the leg portion 4c of the negative electrode lead 4 extends. The second plate portion 92b may include only one of the upper protrusion 920 or the lower protrusion 921. That is, the second plate portion 92b includes at least one of the upper protrusion 920 or the lower protrusion 921.

Herein, a case where the second plate portion 92b includes both the upper protrusion 920 and the lower protrusion 921 will be described. As shown in FIG. 8, the second plate portion 92b includes: a connected side 922 connected to the first plate portion 92a; and an upper unconnected side 920a and a lower unconnected side 921a that are continuous with the connected side 922 and not connected to the first plate portion 92a. The second plate portion 92b further includes a counter side 923 positioned on the opposite side of the connected side 922, the upper unconnected side 920a, and the lower unconnected side 921a.

The upper protrusion 920 of the second plate portion 92b is a portion defined by an outer edge including the upper unconnected side 920a, an upper counter side 920b, which is a part of the counter side 923, and an upper side 920c perpendicular to the upper unconnected side 920a and the upper counter side 920b. The upper counter side 920b refers to a side of a portion of the counter side 923 that opposes the upper unconnected side 920a. The outer edge of the upper protrusion 920 further includes: a corner portion 920d at which the upper unconnected side 920a and the upper side 920c intersect each other; and a corner portion 920e at which the upper counter side 920b and the upper side 920c intersect each other.

The lower protrusion 921 of the second plate portion 92b is a portion defined by an outer edge including the lower unconnected side 921a, a lower counter side 921b, which is a part of the counter side 923, and a lower side 921c perpendicular to the lower unconnected side 921a and the lower counter side 921b. The lower counter side 921b refers to a side of a portion of the counter side 923 that opposes the lower unconnected side 921a. The outer edge of the lower protrusion 921 further includes: a corner portion 921d at which the lower unconnected side 921a and the lower side 921c intersect each other; and a corner portion 921e at which the lower counter side 921b and the lower side 921c intersect each other.

The cover plate portion 92, the negative electrode current-collecting tab 22a wound into multiple layers, the joint plate portion 91, and the leg portion 4c of the negative electrode lead 4 are joined in this order at joint portions J1, J2, and J3. Each of the joint portions J1 to J3 may be formed through an ultrasonic joining process to be described later. The battery according to the embodiment may include one or more joint portions between the negative electrode backup lead 9 and the negative electrode current-collecting tab 22a, but preferably includes three or more joint portions. When there are three or more joint portions, the negative electrode backup lead 9 is less likely to be detached from the wound electrode group 2 and the negative electrode lead 4 even when the battery shakes, and the electrical resistance at the joint portions can be reduced. The shape of the joint portions J1 to J3 is not particularly limited. The joint portions J1 to J3 are arranged in a line along the direction in which the leg portion 4c of the negative electrode lead 4 extends.

In FIG. 6, the joint portion J2 is positioned at the center in the longitudinal direction of the second plate portion 92b. The joint portions J1 and J3 are positioned symmetrically with respect to the longitudinal direction of the second plate portion 92b with the joint portion J2 as the center of symmetry. The joint portions J1 and J3 may be positioned either closer to, or farther from, the joint portion J2. That is, the joint portions J1 to J3 may not be present at equal intervals.

For example, the positions of the joint portions J1 to J3 may vary along the longitudinal direction of the second plate portion 92b while maintaining the positional relationship of the equal interval. The positions of the joint portions J1 to J3 may be closer to the upper protrusion 920 or closer to the lower protrusion 921. For example, the positions of the joint portions Ji to J3 are preferably closer to the upper protrusion 920 along the longitudinal direction of the second plate portion 92b while maintaining the positional relationship of the equal interval. This allows the electrical path from the negative electrode current-collecting tab 22a to the negative electrode terminal 7 to be shortened and a low-resistance battery to be obtained, which is thus favorable.

As shown in FIG. 6, the upper unconnected side 920a and the upper counter side 920b included in the upper protrusion 920 are curved toward one of the two ends along the winding axis direction of the wound electrode group 2 that includes the negative electrode current-collecting tab 22a wound into multiple layers. Likewise, the lower unconnected side 921a and the lower counter side 921b included in the lower protrusion 921 are curved toward one of the two ends along the winding axis direction of the wound electrode group 2 that includes the negative electrode current-collecting tab 22a wound into multiple layers. However, for the sake of convenience, FIGS. 7 to 10 show the case where the upper protrusion 920 and the lower protrusion 921 of the negative electrode backup lead 9 are not curved. A method of curving the upper unconnected side 920a and the upper counter side 920b included in the outer edge of the upper protrusion 920 and the lower unconnected side 921a and the lower counter side 921b included in the outer edge of the lower protrusion 921 will be described later.

When the upper counter side 920b and the lower counter side 921b are curved toward one end of the wound electrode group 2 as described above, the impregnating properties of the electrolytic solution in the vicinity of the winding axis of the wound electrode group 2 are enhanced, as compared with the case where they are not curved. In the wound electrode group 2, a boundary 220 between the negative electrode active material-containing layer (coated portion) 22b and the negative electrode current-collecting tab (non-coated portion) 22a is provided, for example, along a direction perpendicular to the winding axis direction of the wound electrode group 2. When the direction of the boundary 220 is parallel to the upper counter side 920b or the lower counter side 921b, the movement of the electrolytic solution that attempts to permeate the coated portion in the direction along the winding axis direction tends to be prevented because the negative electrode backup lead 9 clamps the negative electrode current-collecting tab 22a with sufficient joining strength.

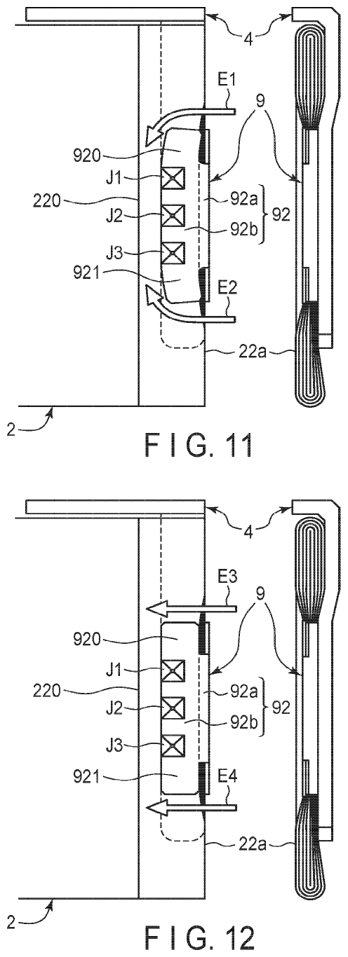

FIG. 11 is a diagram schematically showing an example of a flow of an electrolytic solution in the battery shown in FIG. 6. FIG. 11 shows a flow El and a flow E2 of the electrolytic solution. For example, the electrolytic solution penetrates into the gaps between the layers of the negative electrode current-collecting tab 22a, and then penetrates toward the coated portion. At this occasion, when the upper counter side 920b included in the outer edge of the upper protrusion 920 is curved toward one end of the wound electrode group 2, the electrolytic solution passing through the vicinity of the negative electrode backup lead 9 easily penetrates toward the vicinity of the winding axis of the wound electrode group 2. Therefore, the battery according to the embodiment has excellent charge-and-discharge characteristics. Likewise, when the lower counter side 921b included in the outer edge of the lower protrusion 921 is curved toward one end of the wound electrode group 2, the electrolytic solution passing through the vicinity of the negative electrode backup lead 9 easily penetrates toward the vicinity of the winding axis of the wound electrode group 2.

FIG. 12 shows an example of a flow of an electrolytic solution in a battery according to a reference example. The battery shown in FIG. 12 has the same structure as that of the battery shown in FIG. 6, except that the upper counter side 920b and the upper unconnected side 920a, and the lower counter side 921b and the lower unconnected side 921a are not curved. For example, the electrolytic solution penetrates in parallel with a direction perpendicular to the direction along the boundary 220 between the negative electrode active material-containing layer (coated portion) 22b and the negative electrode current-collecting tab (non-coated portion) 22a, that is, in parallel with the winding axis direction. FIG. 12 shows the flow of the electrolytic solution in this case as E3 and E4. In this case, the amount of the electrolytic solution penetrating in the vicinity of the winding axis is likely to decrease because the negative electrode backup lead 9 clamps the negative electrode current-collecting tab 22a with sufficient joining strength. As a result, the charge-and-discharge efficiency tends to be inferior to that of the battery according to the embodiment.

Further, in the battery shown in FIG. 6, the corner portion 920d at which the upper unconnected side 920a and the upper side 920c intersect is positioned between an extension line of the connected side 922 connecting the first plate portion 92a and the second plate portion 92b and one end side of the wound electrode group 2 (connection plate portion 93 side). Therefore, the negative electrode backup lead 9 does not interfere with the attachment of the negative electrode insulating cover, and does not adversely affect the housing of the wound electrode group 2 in the outer can 1.

The battery according to the embodiment shown in FIG. 6, for example, can achieve excellent impregnating properties of the electrolytic solution and good storability without changing the area of the cover plate portion 92, as compared with the battery according to the reference example shown in FIG. 12, for example. With excellent storability, the electrode group can be housed in a smaller outer can, to achieve a high capacity.

In the negative electrode backup lead 9 shown in FIGS. 6 to 10, etc., the upper counter side 920b is curved toward one end of the wound electrode group 2 at an angle of, for example, 1° to 30°, preferably 1° to 16° with respect to the direction in which the leg portion 4c of the negative electrode lead 4 extends. Excessive curvature of the upper counter side 920b tends to lead to excessive curvature of the upper unconnected side 920a. For example, in this case, an unfavorable situation may occur in which the upper unconnected side 920a and the corner portion 920d protrude relative to the connection plate portion 93 in a direction parallel to the winding axis direction, and the negative electrode insulating cover 11 is damaged.

In a manner similar to the upper counter side 920b, the upper unconnected side 920a is also curved toward one end of the wound electrode group 2 at an angle of, for example, 1° to 30°, preferably 1° to 16° with respect to the direction in which the leg portion 4c of the negative electrode lead 4 extends.

The lower counter side 921b is curved toward one end of the wound electrode group 2 at an angle of, for example, 1° to 30°, preferably 1° to 16° with respect to the direction in which the leg portion 4c of the negative electrode lead 4 extends. Excessive curvature of the lower counter side 921b tends to lead to excessive curvature of the lower unconnected side 921a. For example, in this case, an unfavorable situation may occur in which the lower unconnected side 921a and the corner portion 921d protrude relative to the connection plate portion 93 in a direction parallel to the winding axis direction, and the negative electrode insulating cover 11 is damaged.

In a manner similar to the lower counter side 921b, the lower unconnected side 921a is also curved toward one end of the wound electrode group 2 at an angle of, for example, 1° to 30°, preferably 1° to 16° with respect to the direction in which the leg portion 4c of the negative electrode lead 4 extends.

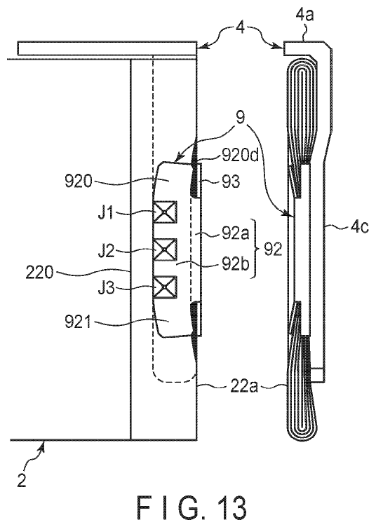

FIG. 13 is an enlarged view of the front and the side of a periphery of a negative electrode backup lead of another example of the battery according to the embodiment. The battery has the same configuration as that shown in FIG. 6, except that the ends of the upper protrusion 920 and the lower protrusion 921 of the negative electrode backup lead 9 are turned up in a direction away from the negative electrode current-collecting tab 22a. In this case, the corner portion 920d is not excessively pushed into the negative electrode current-collecting tab 22a wound into multiple layers. Thus, the negative electrode current-collecting tab 22a is less likely to break. Accordingly, the battery having the configuration shown in FIG. 13 demonstrates excellent safety.

All of the corner portions of the negative electrode backup lead 9 may or may not be chamfered. For example, the corner portions of the joint plate portion 91 and the second plate portion 92b may be chamfered, as shown in FIGS. 6 to 10, etc. Alternatively, the corner portions of the negative electrode backup lead 9 may have an “R” shape.

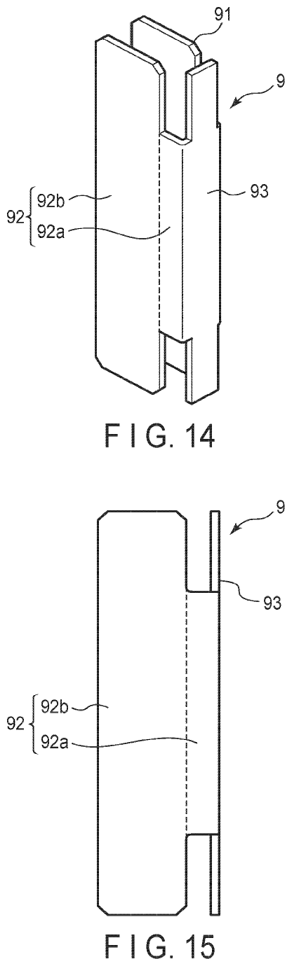

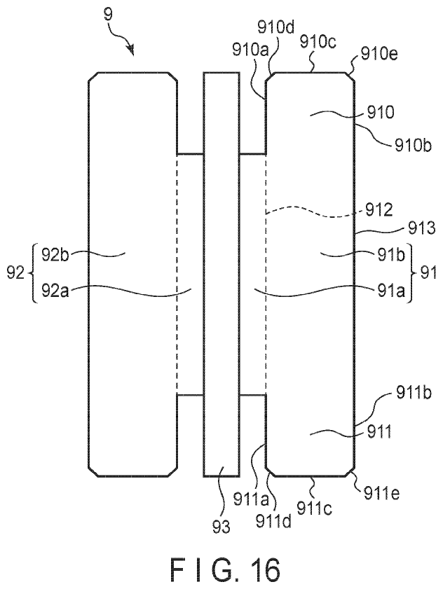

Another aspect of the battery according to the embodiment will be described with reference to FIGS. 14 to 16. FIG. 14 is a perspective view showing another example of the negative electrode backup lead that may be included in the battery of the embodiment. FIG. 15 is a front view of the negative electrode backup lead shown in FIG. 14, as viewed from the side. FIG. 16 is a front view of the negative electrode backup lead shown FIG. 14 in an unfolded state. As shown in the unfolded view of FIG. 16, the joint plate portion 91 of the negative electrode backup lead 9 may include: a third plate portion 91a adjacent to the connection plate portion 93 and forming a part of the joint plate portion 91; and a fourth plate portion 91b continuously extending from the third plate portion and forming another part of the joint plate portion 91.

The fourth plate portion 91b includes an upper protrusion 910 and a lower protrusion 911 protruding relative to the third plate portion 91a along the direction in which the leg portion 4c of the negative electrode lead 4 extends. The fourth plate portion 91b may include at least one of the upper protrusion 910 or the lower protrusion 911.

As best shown in FIG. 16, the fourth plate portion 91b includes: a connected side 912 connected to the third plate portion 91a; and an upper unconnected side 910a and a lower unconnected side 911a that are continuous with the connected side 912 and unconnected to the third plate portion 91a. The fourth plate portion 91b further includes a counter side 913 positioned on the opposite side of the connected side 912, the upper unconnected side 910a, and the lower unconnected side 911a.

When the fourth plate portion 91b includes the upper protrusion 910, the upper protrusion 910 is defined by an outer edge including the upper unconnected side 910a, an upper counter side 910b, which is a part of the counter side 913, and an upper side 910c perpendicular to the upper unconnected side 910a and the upper counter side 910b. The upper counter side 910b refers to a side of a portion of the counter side 913 that opposes the upper unconnected side 910a. The outer edge of the upper protrusion 910 further includes: a corner portion 910d at which the upper unconnected side 910a and the upper side 910c intersect; and a corner portion 910e at which the upper counter side 910b and the upper side 910c intersect.

When the fourth plate portion 91b includes the lower protrusion 911, the lower protrusion 911 is defined by an outer edge including the lower unconnected side 911a, a lower counter side 911b, which is a part of the counter side 913, and a lower side 911c perpendicular to the lower unconnected side 911a and the lower counter side 911b. The lower counter side 911b refers to a side of a portion of the counter side 913 that opposes the lower unconnected side 911a. The outer edge of the lower protrusion 911 further includes: a corner portion 911d at which the lower unconnected side 911a and the lower side 911c intersect; and a corner portion 911e at which the lower counter side 911b and the lower side 911c intersect.

Although not shown in the figure, the upper unconnected side 910a and the upper counter side 910b of the fourth plate portion 91b may be curved toward one of the two ends along the winding axis direction of the wound electrode group 2 that includes the negative electrode current-collecting tab 22a wound into multiple layers. In this case, as in the case where the upper protrusion 920 and the lower protrusion 921 of the cover plate portion 92 are curved, the impregnating properties of the electrolyte solution in the vicinity of the winding axis of the wound electrode group 2 are enhanced. Also in this case, the corner portion 910d, at which the upper unconnected side 910a and the upper side 910c included in the fourth plate portion 91b intersect, is positioned between an extension line of the connected side 912 connecting the third plate portion 91a and the fourth plate portion 91b and one end side of the wound electrode group 2 (connection plate portion 93 side). Therefore, the negative electrode backup lead 9 does not interfere with the attachment of the negative electrode insulating cover, and does not adversely affect the housing of the wound electrode group 2 in the outer can 1. That is, good storability can be achieved, allowing the electrode group to be housed in a smaller outer can, leading to high capacity.

The lower unconnected side 911a and the lower counter side 911b included in the fourth plate portion 91b is curved toward one of the two ends along the winding axis direction of the wound electrode group 2 that includes the negative electrode current-collecting tab 22a wound into multiple layers. In this case as well, the same effects as in the case where the upper unconnected side 910a and the upper side 910c are curved can be obtained.

When not only the upper protrusion 920 and/or the lower protrusion 921 of the cover plate portion 92 but also the upper protrusion 910 and/or the lower protrusion 911 of the joint plate portion 91 are curved toward one end of the wound electrode group 2, as shown in FIGS. 14 to 16, a battery with superior impregnating properties of the electrolytic solution and lower resistance can be obtained.

Next, a method of curving the upper protrusion 920 and/or the lower protrusion 921 of the cover plate portion 92 toward one end of the wound electrode group 2 will be described. An example of the curving method is ultrasonic joining performed when the negative electrode current-collecting tab 22a wound into multiple layers is clamped by the negative electrode backup lead 9. That is, by performing ultrasonic joining, the upper counter side 920b and the upper unconnected side 920a of the upper protrusion 920, and the lower counter side 921b and the lower unconnected side 921a of the lower protrusion 921 can be curved toward one end of the wound electrode group 2. Owing to the ultrasonic joining, the upper protrusion 910 and/or the lower protrusion 911 of the joint plate portion 91 can also be curved toward one end of the wound electrode group 2.

Instead of performing ultrasonic joining on the negative electrode current-collecting tab 22a and the negative electrode backup lead 9, bending may be performed on the negative electrode backup lead 9 in advance. In this case as well, the upper protrusion 920 and/or the lower protrusion 921 of the cover plate portion 92 and the upper protrusion 910 and/or the lower protrusion 911 of the joint plate portion 91 can be curved toward one end of the wound electrode group 2.

Also, owing to the ultrasonic joining, a structure in which the ends of the upper protrusion 920 and the lower protrusion 921 of the negative electrode backup lead 9 are turned up in a direction away from the negative electrode current-collecting tab 22a can be produced. Said structure can also be produced by bending the negative electrode backup lead 9 either before or after joining.

When performing ultrasonic joining, firstly, the negative electrode current-collecting tab 22a of the wound electrode group 2 is clamped by the joint plate portion 91 and the cover plate portion 92 of the negative electrode backup lead 9. At this time, the negative electrode backup lead 9 is placed so that the connection plate portion 93 covers an end surface side of the wound electrode group 2. Next, the leg portion 4c of the negative electrode lead 4 is placed on a receiving table (anvil). The joint plate portion 91 of the negative electrode backup lead 9, the negative electrode current-collecting tab 22a wound into multiple layers, and the cover plate portion 92 of the negative electrode backup lead 9 are arranged to be stacked on the leg portion 4c in this order. At this time, the joint plate portion 91, the negative electrode current-collecting tab 22a, and the cover plate portion 92 are arranged so that the leg portion 4c of the negative electrode lead 4 and the joint plate portion 91 of the negative electrode backup lead 9 come into contact with each other. Next, an appropriate ultrasonic resonator (horn) is vertically pressed against the anvil from the cover plate portion 92 side, and ultrasonic waves are emitted for a predetermined time. Thus, the ultrasonic joining is completed, and the joint portions J1 to J3 shown in FIG. 6, for example, are formed. By appropriately adjusting the shape of the horn, the load (pressure), the amplitude, the time, and the pushing amount, it is possible to control the degree of curvature of the upper protrusion 920 and/or the lower protrusion 921 of the cover plate portion 92 and the upper protrusion 910 and/or the lower protrusion 911 of the joint plate portion 91.

In the battery according to the embodiment, each of the positive electrode lead 3 and the negative electrode lead 4 includes one leg portion. Since the positive electrode lead and the negative electrode lead each include one leg portion, either the positive electrode current-collecting tab wound into multiple layers or the negative electrode current-collecting tab wound into multiple layers is clamped by a single backup lead. That is, the positive electrode backup lead collectively clamps the positive electrode current-collecting tab wound into multiple layers, and the negative electrode backup lead collectively clamps the negative electrode current-collecting tab wound into multiple layers.

In the case of collectively clamping the current-collecting tab with many layers by using a single backup lead, the amount of push of the horn needs to be increased in order to achieve sufficient joining strength. However, the width of the tab near the center of the winding axis (the width parallel to the winding axis direction) is the same as the width of the tab near the outer periphery of the winding axis. Therefore, the tab near the outer periphery of the winding axis is excessively pulled by the sinking of the horn during ultrasonic joining, and is easily broken by the propagation of ultrasonic vibration energy. In order to suppress such breakage, the position where the ultrasonic joining is performed is preferably closer to the coated portion side than one end (end surface) of the wound electrode group 2.

The joint position between the negative electrode backup lead 9 and the negative electrode current-collecting tab 22a wound into multiple layers is preferably closer to the negative electrode active material-containing layer 22b (coated portion) than the center of the width of the negative electrode current-collecting tab 22a. In regard to the positive electrode current-collecting tab 20a as well, the joint position between the positive electrode backup lead 8 and the positive electrode current-collecting tab 20a wound into multiple layers is preferably closer to the positive electrode active material-containing layer 20b (coated portion) than the center of the width of the positive electrode current-collecting tab 20a. When the joint position between the backup lead (first lead) and the current-collecting tab is closer to the coated portion side in each electrode, the following advantages are obtained. Namely, since breakage of the current-collecting tab can be suppressed, a short circuit caused by a broken current-collecting tab coming into contact with the outer can 1 and the other electrode can be suppressed. Also, since an increase in the density of the current flowing through the unbroken current-collecting tab can be prevented, an excessive load on the electrode can be avoided. Since no large tensile force is applied to the current-collecting tab, breakage of the current-collecting tab is more easily suppressed when a physical impact occurs while the battery is moved or used.

As described with reference to FIGS. 6 to 10, etc., the second plate portion 92b of the negative electrode backup lead 9 includes the upper protrusion 920 and/or the lower protrusion 921 that protrude relative to the first plate portion 92a along the direction in which the leg portion 4c of the negative electrode lead 4 extends. Therefore, the width of the second plate portion 92b in the longitudinal direction is larger than the width of the first plate portion 92a in the longitudinal direction. Here, the longitudinal direction is a direction parallel to the direction in which the leg portion 4c of the negative electrode lead 4 extends. Therefore, the width of the second plate portion 92b in the longitudinal direction is the maximum length of the second plate portion 92b in the direction in which the leg portion 4c extends. The width of the first plate portion 92a in the longitudinal direction is the maximum length of the first plate portion 92a in the direction in which the leg portion 4c extends. The width of the joint plate portion 91 in the longitudinal direction is the maximum length of the joint plate portion 91 in the direction in which the leg portion 4c extends.

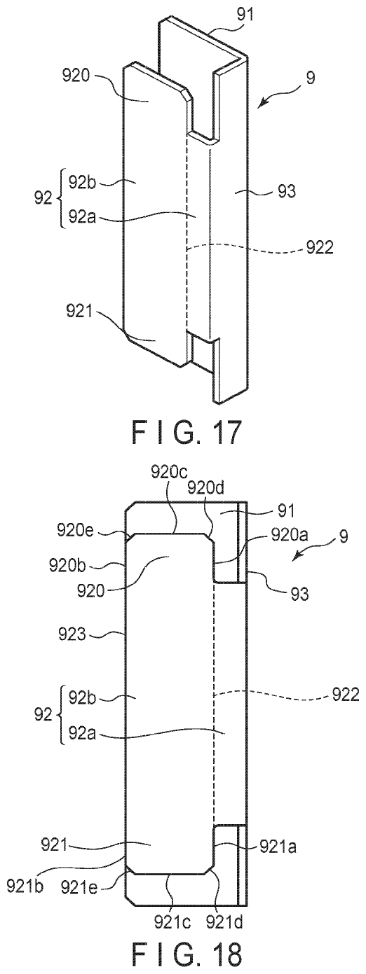

The width of the second plate portion 92b in the longitudinal direction may be the same as the width of the joint plate portion 91 in the longitudinal direction, as in the case of the negative electrode backup lead 9 shown in FIGS. 6 to 10, for example. The width of the second plate portion 92b in the longitudinal direction may be smaller or larger than the width of the joint plate portion 91 in the longitudinal direction. The width of the second plate portion 92b in the longitudinal direction is preferably less than the width of the joint plate portion 91 in the longitudinal direction. An example of this case is shown in FIGS. 17 and 18. The negative electrode backup lead 9 shown in FIGS. 17 and 18 has the same structure as that of the negative electrode backup lead 9 described above with reference to FIGS. 7 to 10, except that the width of the second plate portion 92b in the longitudinal direction is less than the width of the joint plate portion 91 in the longitudinal direction.

When the length of the second plate portion 92b in the longitudinal direction is less than the width of the joint plate portion 91 in the longitudinal direction, it is possible to prevent the upper counter side 920b and the upper unconnected side 920a, which are included in the outer edge of the upper protrusion 920 of the second plate portion 92b, from being excessively curved during ultrasonic joining. It is also possible to prevent the lower counter side 921b and the lower unconnected side 921a, which are included in the outer edge of the lower protrusion 921 of the second plate portion 92b, from being excessively curved. In this case, it is possible to prevent the ends of the upper protrusion 920 and the lower protrusion 921 of the negative electrode backup lead 9 from being excessively turned up in a direction away from the negative electrode current-collecting tab 22a. Therefore, when the width of the second plate portion 92b in the longitudinal direction is smaller than the width of the joint plate portion 91 in the longitudinal direction, it is possible to obtain the effects of improving battery safety and assemblability, as well as improving battery capacity.

The width of the connection plate portion 93 in the longitudinal direction is greater than the width of the first plate portion 92a in the longitudinal direction, as in the case of the negative electrode backup lead 9 shown in FIGS. 6 to 10, for example. The width of the connection plate portion 93 in the longitudinal direction is the same as the width of the joint plate portion 91 in the longitudinal direction, as in the case of the negative electrode backup lead 9 shown in FIGS. 6 to 10, for example. The width of the connection plate portion 93 in the longitudinal direction may be smaller or larger than the width of the joint plate portion 91 in the longitudinal direction. The width of the connection plate portion 93 in the longitudinal direction is the maximum length of the connection plate portion 93 in the direction in which the leg portion 4c extends.

The width of the connection plate portion 93 in the longitudinal direction is preferably larger than the width of the first plate portion 92a in the longitudinal direction, as shown in FIGS. 6 to 10, for example. In this case, the area of contact between the negative electrode backup lead 9 and an end (end surface) of the wound electrode group 2 is increased, allowing for further reduction of the electrical resistance. Also in this case, the backup lead is easily fixed to the current-collecting tab portion of the wound electrode group with the use of a jig when performing ultrasonic joining, thus producing an advantage of positional deviation being less likely to occur.

The widths of the joint plate portion 91, the cover plate portion 92, and the connection plate portion 93 in the shorter-side direction are not particularly limited as long as the negative electrode backup lead 9 can be joined to the negative electrode current-collecting tab 22a with sufficient joining strength.

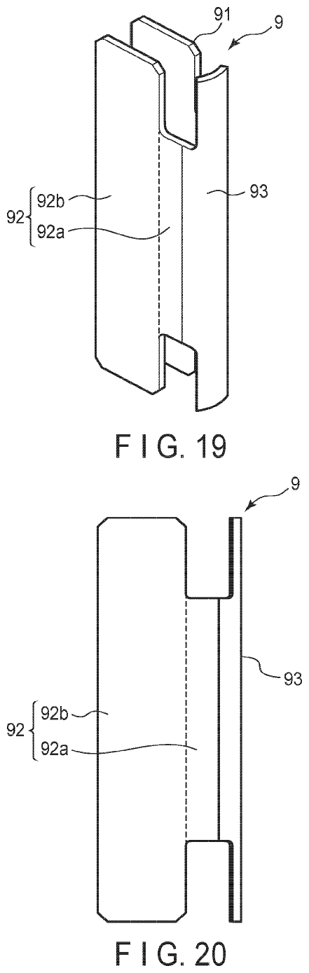

FIGS. 19 and 20 are diagrams schematically showing another example of the backup lead included in the battery according to the embodiment. In the negative electrode backup lead 9 shown in FIGS. 19 and 20, the connection plate portion 93 has a substantially rectangular plate shape. The connection plate portion 93 is curved so as to surround one end of the wound electrode group 2. That is, the connection plate portion 93 has an “R” shape curved in an arch shape along the shorter-side direction of the connection plate portion 93, so that a side opposing one end of the wound electrode group 2 is recessed. Except for this, the negative electrode backup lead 9 shown in FIGS. 19 and 20 has the same structure as that of the negative electrode backup lead 9 described with reference to FIGS. 17 and 18. When the connection plate portion 93 has a substantially rectangular plate shape and is curved so as to surround one end of the wound electrode group 2, the entire connection plate portion 93 easily comes into contact with the end surface of the wound electrode group 2, and, as a result, the favorable situation occurs in which electrical resistance is reduced. Also, since the end of the connection plate portion 93 in the longitudinal direction is less likely to be deformed in a direction away from one end of the wound electrode group 2, the favorable situation occurs in which the negative electrode insulating cover 11 is less likely to be damaged.

A positive electrode, negative electrode, separator, and nonaqueous electrolyte of the battery according to the embodiment will be described in detail below.

(1) Positive Electrode

The positive electrode may include, for example, a positive electrode current collector, a positive electrode active material-containing layer supported on the positive electrode current collector, and a positive electrode current-collecting tab. The positive electrode active material-containing layer may include, for example, a positive electrode active material, a conductive agent, and a binder.

For example, an oxide or a sulfide may be used as the positive electrode active material. Examples of the oxide and the sulfide include manganese dioxide (MnO₂) for inserting lithium, iron oxide, copper oxide, nickel oxide, lithium-manganese composite oxide (e.g., LiₓMn₂O₄ or LiₓMnO₂), lithium-nickel composite oxide (e.g., LiₓNiO₂), lithium-cobalt composite oxide (e.g., LiₓCoO₂), lithium-nickel-cobalt composite oxide (e.g., LiNi_{1-y}Co_{y}O₂), lithium-manganese-cobalt composite oxide (e.g., LiₓMn_{y}Co_{1-y}O₂), lithium-manganese-nickel composite oxide having a spinel structure (e.g., LiₓMn_{2-y}Ni_{y}O₄), lithium phosphorus oxide having an olivine structure (e.g., LiₓFePO₄, LiₓFe_{1-y}Mn_{y}PO₄, and LiₓCoPO₄), ferrous sulfate (Fe₂(SO₄)₃), vanadium oxide (e.g., V₂O₅), and lithium-nickel-cobalt-manganese composite oxide. In the above formulas, 0<x≤1 and 0<y≤1. These compounds may be used alone or in combination as the active material.

The binder is added to bind the active material and the current collector. Examples of the binder include polytetrafluoro-ethylene (PTFE), polyvinylidene fluoride (PVdF), and fluorine rubber.

The conductive agent is added to enhance current collecting performance and suppress the contact resistance between the active material and the current collector. Examples of the conductive agent include carbonaceous materials such as acetylene black, carbon black, and graphite.

In the positive electrode active material-containing layer, the positive electrode active material and the binder are preferably blended in proportions of 80% by mass to 98% by mass, and 2% by mass to 20% by mass, respectively.

When the amount of the binder is 2% by mass or more, sufficient electrode strength can be obtained. When the amount of the binder is 20% by mass or less, the content of an insulating material in the electrode can be reduced, as can the internal resistance.

When the conductive agent is added, the positive electrode active material, the binder, and the conductive agent are preferably blended in proportions of 77% by mass to 95% by mass, 2% by mass to 20% by mass, and 3% by mass to 15% by mass, respectively. When the amount of the conductive agent is 3% by mass or more, the above-described effects can be achieved. When the amount of the conductive agent is 15% by mass or less, decomposition of the nonaqueous electrolyte on the surface of the positive electrode conductive agent during high-temperature storage can be reduced.

The positive electrode current collector is preferably an aluminum foil or an aluminum alloy foil containing at least one element selected from Mg, Ti, Zn, Ni, Cr, Mn, Fe, Cu and Si.

The positive electrode current collector is preferably integrated with the positive electrode current-collecting tab. Alternatively, the positive electrode current collector may be separate from the positive electrode current-collecting tab.

(2) Negative Electrode

The negative electrode may include, for example, a negative electrode current collector, a negative electrode active material-containing layer supported on the negative electrode current collector, and a negative electrode current-collecting tab. The negative electrode active material-containing layer may include, for example, a negative electrode active material, a conductive agent, and a binder.

For example, a metal oxide, a metal nitride, an alloy, carbon, or the like that allows lithium ions to be inserted and extracted can be used as the negative electrode active material. A material that allows lithium ions to be inserted and extracted at a high potential of 0.4 V or more (vs. Li/Li⁺) is preferably used as the negative electrode active material.

The conductive agent is added to enhance current collecting performance and to suppress the contact resistance between the negative electrode active material and the current collector. Examples of the conductive agent include carbonaceous materials such as acetylene black, carbon black, and graphite.

The binder is added to fill gaps among the dispersed negative electrode active material, and also to bind the negative electrode active material and the current collector. Examples of the binder include polytetrafluoro-ethylene (PTFE), polyvinylidene fluoride (PVdF), fluorine rubber, and styrene-butadiene rubber.

The active material, the conductive agent, and the binder in the negative electrode active material-containing layer are preferably blended in proportions of 68% by mass to 96% by mass, 2% by mass to 30% by mass, and 2% by mass to 30% by mass, respectively. When the amount of the conductive agent is 2% by mass or more, the current collecting performance of the negative electrode active material-containing layer can be improved. When the amount of the binder is 2% by mass or more, the binding between the negative electrode active material-containing layer and the current collector can be sufficiently exhibited, and excellent cycle characteristics can be expected. On the other hand, from a standpoint of increased capacity, the amount of each of the conductive agent and the binder is preferably 28% by mass or less.

As the current collector, a material which is electrochemically stable at the lithium insertion and extraction potential of the negative electrode active material is used. The current collector is preferably made of copper, nickel, stainless steel, aluminum, or an aluminum alloy containing at least one element selected from Mg, Ti, Zn, Mn, Fe, Cu, and Si. The thickness of the current collector is preferably in the range of 5 to 20 μm. The current collector having such a thickness can maintain balance between the strength and weight reduction of the negative electrode.

The negative electrode current collector is preferably integrated with the negative electrode current-collecting tab. Alternatively, the negative electrode current collector may be separate from the negative electrode current-collecting tab.

The negative electrode is produced by, for example, suspending the negative electrode active material, the binder, and the conductive agent in a widely used solvent to prepare a slurry, applying the slurry onto the current collector and drying the slurry to form the negative electrode active material-containing layer, and thereafter pressing the negative electrode active material-containing layer. The negative electrode may also be produced by shaping the negative electrode active material, the binder, and the conductive agent into pellets to form the negative electrode active material-containing layer, and arranging the negative electrode active material-containing layer on the current collector.

(3) Separator

The separator may be made of, for example, a porous film or a synthetic resin nonwoven fabric including polyethylene, polypropylene, cellulose, or polyvinylidene fluoride (PVdF). In particular, a porous film made of polyethylene or polypropylene melts at a certain temperature and is capable of interrupting a current, leading to improved safety.

(4) Electrolytic Solution

For example, a nonaqueous electrolyte can be used as the electrolytic solution.

The nonaqueous electrolyte may be, for example, a liquid nonaqueous electrolyte prepared by dissolving an electrolyte in an organic solvent, or a gel nonaqueous electrolyte obtained by combining a liquid electrolyte and a polymeric material.

The liquid nonaqueous electrolyte is preferably an electrolyte dissolved in an organic solvent at a concentration of 0.5 mol/L to 2.5 mol/L.

Examples of the electrolyte dissolved in an organic solvent include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethanesulfonate (LiCF₃SO₃), and bistrifluoromethylsulfonylimide lithium [LiN(CF₃SO₂)₂], and mixtures thereof. The electrolyte is preferably resistant to oxidation even at a high potential, and LiPF₆ is most preferred.

Examples of the organic solvent include: cyclic carbonates such as propylene carbonate (PC), ethylene carbonate (EC), and vinylene carbonate; chain carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolan (DOX); chain ethers such as dimethoxyethane (DME) and diethoxyethane (DEE); and γ-butyrolactone (GBL), acetonitrile (AN), and sulfolane (SL). These organic solvents may be used either alone or as a mixed solvent.

Examples of the polymeric material include polyvinylidene fluoride (PVdF), polyacrylonitrile (PAN), and polyethylene oxide (PEO).

Alternatively, a room temperature molten salt (ionic melt) containing lithium ions, a polymer solid electrolyte, an inorganic solid electrolyte, or the like may be used as the nonaqueous electrolyte.

The room temperature molten salt (ionic melt) refers to compounds which may exist in the form of a liquid at room temperature (15° C. to 25° C.) among organic salts formed of combinations of organic cations and anions. The room temperature molten salt includes room temperature molten salts which exist alone in the form of a liquid, room temperature molten salts which become a liquid when mixed with an electrolyte, and room temperature molten salts which become a liquid when dissolved in an organic solvent. In general, the melting point of room temperature molten salts used in a nonaqueous electrolyte battery is 25° C. or less. Also, organic cations generally have a quaternary ammonium framework.

The battery according to the first embodiment includes: an outer can including a side wall and a bottom wall and including an opening on an opposite side of the bottom wall; an electrolytic solution; a wound electrode group housed in the outer can so that a winding axis direction of the wound electrode group intersects with the side wall, and including a current-collecting tab wound into multiple layers arranged at at least one end of the wound electrode group; a first lead clamping the current-collecting tab wound into multiple layers; a second lead electrically connected to the first lead; and a metallic lid attached to the opening of the outer can and including a terminal. The first lead includes: a joint plate portion electrically connected to the second lead; a cover plate portion opposing the joint plate portion with the current-collecting tab wound into multiple layers interposed therebetween; and a connection plate portion connecting the joint plate portion and the cover plate portion and facing at least one end of the wound electrode group. The second lead includes a substrate electrically connected to the terminal, and a leg portion extending in a direction perpendicular to the winding axis direction of the wound electrode group, wherein the leg portion is electrically connected to the joint plate portion. The cover plate portion includes: a first plate portion adjacent to the connection plate portion and forming a part of the cover plate portion; and a second plate portion extending continuously from the first plate portion and forming another part of the cover plate portion. The second plate portion includes: a connected side connected to the first plate portion; an unconnected side extending along a direction in which the connected side extends and not connected to the first plate portion; and a counter side positioned on an opposite side of the connected side and the unconnected side. The second plate portion includes a protrusion protruding relative to the first plate portion along a direction in which the leg portion extends. The unconnected side and a part of the counter side at the protrusion is curved toward at least one end of the wound electrode group. The battery exhibits excellent impregnating properties of an electrolytic solution.

### Second Embodiment

According to a second embodiment, a battery pack is provided. The battery pack includes the battery according to the first embodiment.

The battery pack according to the second embodiment may include a plurality of batteries. The plurality of batteries may be electrically connected in series or electrically connected in parallel. Alternatively, the plurality of batteries may be connected in a combination of in-series and in-parallel.

The battery pack according to the second embodiment may include, for example, five batteries. These batteries may be connected in series. Also, the batteries connected in series may constitute a battery module. That is, the battery pack according to the second embodiment may include a battery module.

The battery pack according to the second embodiment may include a plurality of battery modules. The plurality of battery modules may be connected in series, in parallel, or in a combination of in-series and in-parallel.

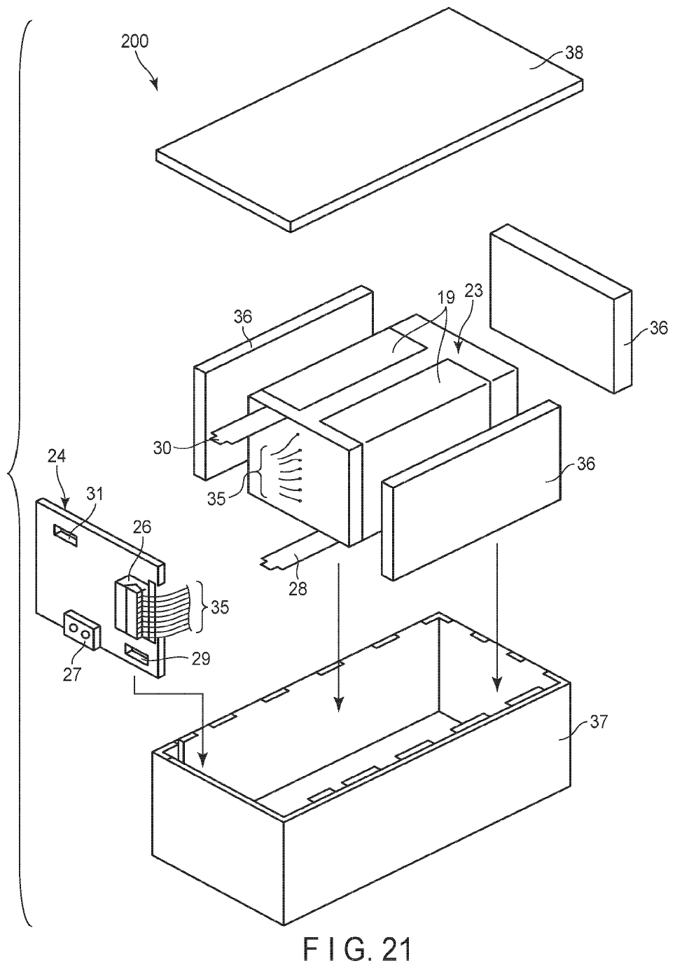

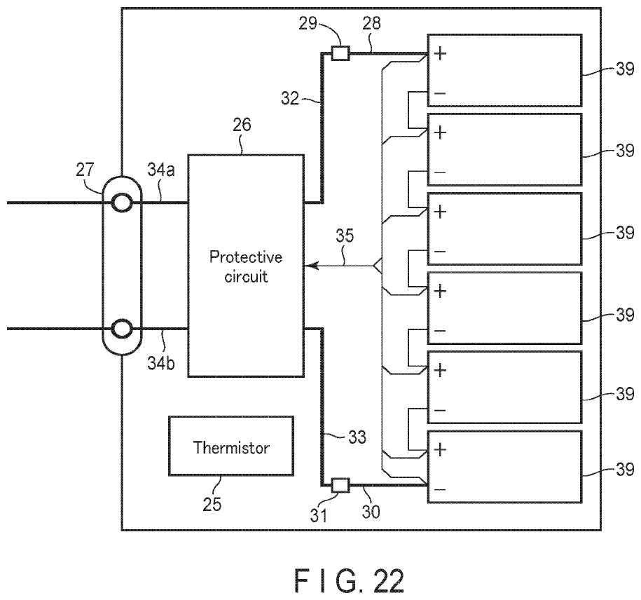

Hereinafter, an example of the battery pack according to the second embodiment will be described with reference to FIGS. 21 and 22. FIG. 21 is an exploded perspective view of an example of the battery pack according to the second embodiment. FIG. 22 is a block diagram showing an example of an electric circuit of the battery pack shown in FIG. 21.

A battery pack 200 shown in FIGS. 21 and 22 includes a battery module 23 formed of a plurality of unit cells 39. The unit cell 39 may be an example of the battery according to the first embodiment described with reference to FIGS. 1 to 5.

As shown in FIG. 22, the plurality of unit cells 39 are electrically connected to each other in series.

A printed wiring board 24 is disposed so as to face the side surface from which a positive electrode-side lead 28 and a negative electrode-side lead 30 of the battery module 23 extend. As shown in FIG. 22, the printed wiring board 24 is provided with a thermistor 25, a protective circuit 26, and a terminal 27 for energizing an external device. An insulating plate (not shown) is attached to the surface of the printed wiring board 24 facing the battery module 23 in order to avoid unnecessary connection with the wiring of the battery module 23.

A distal end of the positive electrode-side lead 28 is inserted into, and electrically connected to, a positive electrode-side connector 29 of the printed wiring board 24.

A distal end of the negative electrode-side lead 30 is inserted into, and electrically connected to, a negative electrode-side connector 31 of the printed wiring board 24. These connectors 29 and 31 are connected to the protective circuit 26 through wires 32 and 33 formed on the printed wiring board 24.

The thermistor 25 detects the temperature of the unit cells 39, so that the detection signals are transmitted to the protective circuit 26. Under a predetermined condition, the protective circuit 26 can shut off a plus-side wire 34a and a minus-side wire 34b between the protective circuit 26 and the terminal 27 for energizing an external device. An example of the predetermined condition is when the temperature detected by the thermistor 25 becomes equal to or higher than a predetermined temperature. Another example of the predetermined condition is when over-charge, over-discharge, overcurrent, or the like of the unit cell 39 is detected. The detection of the over-charge or the like is performed for the individual unit cells 39 or the entire battery module 23. In the case of the detection for the individual unit cells 39, a battery voltage may be detected, or a positive or negative electrode potential may be detected. In the latter case, a lithium electrode used as a reference electrode is inserted into each unit cell 39. In the battery pack 200 shown in FIGS. 21 and 22, a wire 35 for voltage detection is connected to each of the unit cells 39. Detection signals are transmitted to the protective circuit 26 through the wires 35.

Protective sheets 36 made of rubber or resin are arranged on three side surfaces of the battery module 23, excluding the side surface from which the positive electrode-side lead 28 and the negative electrode-side lead 30 protrude.

The battery module 23 is housed in a housing container 37 together with each protective sheet 36 and the printed wiring board 24. That is, the protective sheets 36 are arranged on both of the inner side surfaces in the long-side direction and one of the inner side surfaces in the short-side direction of the housing container 37, and the printed wiring board 24 is arranged on the other inner side surface in the short-side direction. The battery module 23 is positioned in a space surrounded by the protective sheets 36 and the printed wiring board 24. A lid 38 is attached to an upper surface of the housing container 37.

A heat-shrinkable tape may be used to fix the battery module 23 instead of an adhesive tape 19. In this case, protective sheets are arranged on both of the side surfaces of the battery module, and the heat-shrinkable tape is wound around the battery module and then thermally contracted to bind the battery module.

FIGS. 21 and 22 show the configuration in which the unit cells 39 are connected in series; however, the unit cells 39 may be connected in parallel to increase the battery capacity. Further, assembled battery packs may be connected in series and/or in parallel.

The configuration of the battery pack according to the second embodiment is altered appropriately depending on the application. The battery pack according to the second embodiment is preferably used in applications where cycle performance with large current performance is desired. Specific applications are as power supplies for digital cameras, and on-vehicle applications for two- or four-wheel hybrid electric automobiles, two- or four-wheel electric automobiles, assisted bicycles, and the like. The battery pack according to the second embodiment is particularly suitable for use in the on-vehicle applications.

The battery pack according to the second embodiment includes the battery according to the first embodiment. Therefore, the battery pack according to the second embodiment exhibits excellent impregnating properties of the electrolytic solution.

According to at least one embodiment described above, a battery is provided. The battery includes: an outer can including a side wall and a bottom wall and including an opening on an opposite side of the bottom wall; an electrolytic solution; a wound electrode group housed in the outer can so that a winding axis direction of the wound electrode group intersects with the side wall, and including a current-collecting tab wound into multiple layers arranged at at least one end of the wound electrode group; a first lead clamping the current-collecting tab wound into multiple layers; a second lead electrically connected to the first lead; and a metallic lid attached to the opening of the outer can and including a terminal. The first lead includes: a joint plate portion electrically connected to the second lead; a cover plate portion opposing the joint plate portion with the current-collecting tab wound into multiple layers interposed therebetween; and a connection plate portion connecting the joint plate portion and the cover plate portion and facing at least one end of the wound electrode group. The second lead includes a substrate electrically connected to the terminal, and a leg portion extending in a direction perpendicular to the winding axis direction of the wound electrode group, wherein the leg portion is electrically connected to the joint plate portion. The cover plate portion includes: a first plate portion adjacent to the connection plate portion and forming a part of the cover plate portion; and a second plate portion extending continuously from the first plate portion and forming another part of the cover plate portion. The second plate portion includes: a connected side connected to the first plate portion; an unconnected side extending along direction in which the connected side extends and not connected to the first plate portion; and a counter side positioned on an opposite side of the connected side and the unconnected side. The second plate portion includes a protrusion protruding relative to the first plate portion along a direction in which the leg portion extends. The unconnected side and a part of the counter side at the protrusion is curved toward at least one end of the wound electrode group. The battery exhibits excellent impregnating properties of an electrolytic solution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A battery comprising:
an outer can comprising a side wall and a bottom wall and comprising an opening on an opposite side of the bottom wall;
an electrolytic solution;
a wound electrode group housed in the outer can so that a winding axis direction of the wound electrode group intersects with the side wall, the wound electrode group comprising a current-collecting tab wound into multiple layers, the current-collecting tab arranged at at least one end of the wound electrode group;
a first lead clamping the current-collecting tab wound into multiple layers;
a second lead electrically connected to the first lead; and
a metallic lid attached to the opening of the outer can and comprising a terminal,
wherein
the first lead comprises: a joint plate portion electrically connected to the second lead; a cover plate portion opposing the joint plate portion with the current-collecting tab wound into multiple layers interposed therebetween; and a connection plate portion connecting the joint plate portion and the cover plate portion and facing the at least one end of the wound electrode group,
the second lead comprises: a substrate electrically connected to the terminal; and a leg portion extending in a direction perpendicular to the winding axis direction of the wound electrode group, wherein the leg portion is electrically connected to the joint plate portion,
the cover plate portion comprises: a first plate portion adjacent to the connection plate portion and forming a part of the cover plate portion; and a second plate portion extending continuously from the first plate portion and forming another part of the cover plate portion,
the second plate portion comprises: a connected side connected to the first plate portion; an unconnected side extending along a direction in which the connected side extends and not connected to the first plate portion; and a counter side positioned on an opposite side of the connected side and the unconnected side,
the second plate portion comprises a protrusion defined by an outer edge comprising the unconnected side and the counter side, the protrusion protruding relative to the first plate portion along a direction in which the leg portion extends, and
the unconnected side and a part of the counter side at the protrusion is curved toward the at least one end of the wound electrode group.

2. The battery according to claim 1, wherein
the protrusion comprises: an upper protrusion protruding relative to the first plate portion toward the substrate of the second lead along the direction in which the leg portion extends; and a lower protrusion protruding relative to the first plate portion toward a side opposite to the upper protrusion along the direction in which the leg portion extends, and
the upper protrusion is defined by an outer edge comprising an upper unconnected side and an upper counter side, wherein the upper unconnected side is continuous with the connected side and unconnected to the first plate portion, and the upper counter side is comprised in the part of the counter side,
the lower protrusion is defined by an outer edge comprising a lower unconnected side and a lower counter side, wherein the lower unconnected side is continuous with the connected side and unconnected to the first plate portion, and the lower counter side is comprised in the part of the counter side, and
the upper unconnected side, the upper counter side, the lower unconnected side, and the lower counter side are curved toward the at least one end of the wound electrode group.

3. The battery according to claim 1, wherein a width of the connection plate portion in the direction in which the leg portion extends is larger than a width of the first plate portion in the direction in which the leg portion extends.

4. The battery according to claim 1, wherein
the joint plate portion comprises: a third plate portion adjacent to the connection plate portion and forming a part of the joint plate portion; and a fourth plate portion extending continuously from the third plate portion and forming another part of the joint plate portion,
the fourth plate portion comprises: a second connected side connected to the third plate portion; a second unconnected side extending along a direction in which the second connected side extends and not connected to the third plate portion; and a second counter side positioned on an opposite side of the second connected side and the second unconnected side,
the fourth plate portion comprises a second protrusion defined by an outer edge comprising the second unconnected side and the second counter side, the second protrusion protruding relative to the third plate portion along the direction in which the leg portion extends, and
the second unconnected side and a part of the second counter side at the second protrusion is curved toward the at least one end of the wound electrode group.

5. The battery according to claim 1, wherein the connection plate portion has a rectangular plate shape and is curved so as to surround the at least one end of the wound electrode group.

6. The battery according to claim 1, wherein
the wound electrode group comprises a positive electrode current-collecting tab wound into multiple layers and a negative electrode current-collecting tab wound into multiple layers, wherein the positive electrode current-collecting tab is arranged at one end of the wound electrode group in the winding axis direction, and the negative electrode current-collecting tab is arranged at another end of the wound electrode group in the winding axis direction, and
the battery comprises:
a first positive electrode lead collectively clamping the positive electrode current-collecting tab wound into multiple layers;
a first negative electrode lead collectively clamping the negative electrode current-collecting tab wound into multiple layers;
a second positive electrode lead electrically connected to the first positive electrode lead; and
a second negative electrode lead electrically connected to the first negative electrode lead, and
both the first positive electrode lead and the first negative electrode lead are the first lead according to claim 1, and
both the second positive electrode lead and the second negative electrode lead are the second lead according to claim 1.

7. A battery pack comprising the battery according to claim 1.
